(19) United States
(12) Patent Application Publication
(10) Pub. No.: US 2025/0319395 A1
(43) Pub. Date: Oct. 16, 2025

(54) METHOD AND SYSTEM FOR GENERATING GRAPHICAL LAYOUT

(71) Applicant: Supercell Oy, Helsinki (FI)

(72) Inventors: Thomas Samuel Spilsbury, Helsinki (FI); Tele Hao, Helsinki (FI)

(73) Assignee: Supercell Oy, Helsinki (FI)

(21) Appl. No.: 18/633,856

(22) Filed: Apr. 12, 2024

(51) Int. Cl. A63F 13/52; A63F 13/70; G06T 11/00

(52) U.S. Cl. CPC A63F 13/52; A63F 13/70; G06T 11/00

(57) ABSTRACT

Disclosed is method including receiving input graphical layout having cells forming grid structure cells are configured to be placed with objects to form GL; determining placement probability score for cells with respect to objects at first point in time; placing each object into IGL for forming GL, wherein placing given object into IGL include selecting given object, based on predefined placement schedule; identifying constrained cell(s) from amongst cells where predefined constraint(s) is violated if given object is placed thereon; adjusting placement probability score, for constrained cell(s), to be zero; adjusting placement probability score, for each cell of constraint-free cells, based on placement probability score for each cell of CFCs, and adjusted placement probability score for constrained cell(s), wherein given object is placed in constraint-free cell (C4) having highest adjusted placement probability score amongst CFCs.

### TECHNICAL FIELD

The present disclosure relates to methods for generating graphical layouts. Moreover, the present disclosure relates to systems for generating graphical layouts.

### BACKGROUND

In recent times, advancements in a field of procedural content generation has gained popularity over years due to a wide range of applications such as design layouts in gaming applications and user interface optimization. Typically, procedural content generation involves an automated creation of content, such as levels, maps, or layouts, using algorithms and predefined rules. In the domain of the gaming applications, procedural content generation has been widely used to enhance gameplay, increase replayability, and reduce development time. Additionally, the procedural content generation has found applications in other areas of user interface research, where the generation of optimized layouts is crucial for improving user experience and efficiency.

However, in present solutions for the procedural content generation, a significant challenge is constraint satisfaction, particularly in the generation of layouts. Although, present solutions involving denoising diffusion models have been utilized to generate the layouts, but ensuring that the layouts meet a set of hard constraints remains problematic, as the models operate on a continuous domain where the constraints cannot be evaluated until the end of the generation process at the point of discretization. Moreover, present solutions involving objective-based generation, such as Mutation Models, does not require prior data about a desired level design but relies on an objective function to determine what constitutes a good level.

Therefore, in light of the foregoing discussion, there exists a need to overcome the aforementioned drawbacks.

### SUMMARY

The aim of the present disclosure is to provide a method and a system to replicate human-like generation of graphical layouts. The aim of the present disclosure is achieved by a method and a system for generating a graphical layout as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is an illustration of a flowchart depicting steps of a method for generating a graphical layout, in accordance with an embodiment of the present disclosure;

FIG. 2 is a schematic illustration of a system for generating a graphical layout, in accordance with an embodiment of the present disclosure; and

FIG. 3 is a schematic illustration of an input graphical layout at different time instances, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, the present disclosure provides a method for generating a graphical layout, the method comprising:
receiving an input graphical layout having a plurality of cells forming a grid structure, the plurality of cells are configured to be placed with a plurality of objects to form the graphical layout;
determining a placement probability score for each cell of the plurality of cells with respect to each object of the plurality of objects at a first point in time;
placing each object of the plurality of objects into the input graphical layout for forming the graphical layout, wherein placing a given object into the input graphical layout comprises:
   selecting the given object for placement, based on a predefined placement schedule;
   identifying one or more constrained cells from amongst the plurality of cells where at least one predefined constraint is violated if the given object is placed thereon;
   adjusting the placement probability score, for the one or more constrained cells, to be zero;
   adjusting the placement probability score, for each cell of constraint-free cells from amongst the plurality of cells with respect to the given object at a second point in time, based on
      the placement probability score for each cell of the constraint-free cells, and
      the adjusted placement probability score for the one or more constrained cells,
wherein the given object is placed in a constraint-free cell having a highest adjusted placement probability score amongst the constraint-free cells with respect to the given object at the second point in time.

The present disclosure provides an aforementioned method that automates generation of the graphical layout. The method is able to replicate a human-like generation of the graphical layout, which significantly increases efficiency and accuracy of generating the graphical layout, while reducing a time required for generating the graphical layout. Moreover, the method effectively enables implementation of hard constraints in the graphical layout, by ensuring that the at least one predefined constraint does not get violated in placing the plurality of objects in the input graphical layout for forming the graphical layout.

In a second aspect, the present disclosure provides a system for generating a graphical layout, the system comprising a processor configured to:
receive an input graphical layout having a plurality of cells forming a grid structure, the plurality of cells are configured to be placed with a plurality of objects to form the graphical layout;
determine a placement probability score for each cell of the plurality of cells with respect to each object of the plurality of objects at a first point time;
place each object of the plurality of objects into the input graphical layout for forming the graphical layout, wherein placing a given object into the input graphical layout comprises:
   selecting the given object for placement, based on a predefined placement schedule;
   identifying one or more constrained cells from amongst the plurality of cells where at least one predefined constraint is violated if the given object is placed thereon;
   adjusting the placement probability score, for the one or more constrained cells, to be zero;
   adjusting the placement probability score, for each cell of constraint-free cells from amongst the plurality of cells with respect to the given object at a second point in time, based on
      the placement probability score for each cell of the constraint-free cells, and
      the adjusted placement probability score for the one or more constrained cells,

wherein the given object is placed in a constraint-free cell having a highest adjusted placement probability score amongst the constraint-free cells with respect to the given object at the second point in time. 15

The present disclosure provides an aforementioned system that automates generation of the graphical layout. The system is able to replicate a human-like generation of the graphical layout, which significantly increases efficiency and accuracy of generating the graphical layout, while reducing a time required for generating the graphical layout. Moreover, the system effectively enables implementation of hard constraints in the graphical layout, by ensuring that the at least one predefined constraint does not get violated in placing the plurality of objects in the input graphical layout to form the graphical layout. Automatically generated graphical layouts provide further technical effect of being able to generate a large inventory of different type of graphical layouts automatically. This is needed for example when generating different versions of computer programs such as games. In gaming environment graphical layouts could be done in order to generate new levels for the game automatically or as needed (then there is no need to 30 have inventory of layouts but layouts can be generated need to have basis thus reducing amount of memory need in storing pregenerated layouts). Further alternative use case for generated graphical layouts is generating graphical layout for placing real word objects in a storage or for gardening or for making layout scenarios for urban planning purposes. The generated graphical layout can be in such urban planning scenario provide outline where each house, store, road etc should be placed in the area. This way a large amount of proposals can be generated automatically thus avoiding manual labor. Further technical effect of the method is that it provides way to use display surface in optimum way. This way a smaller display can be used to render more content.

Throughout the present disclosure, the term “graphical layout” refers to a graphical representation depicting an arrangement of virtual elements and objects to be displayed in a graphical user interface. Notably, the graphical layout requires various virtual elements such as images, text, colours, icons and the like to be arranged cohesively to create an aesthetically pleasing appearance. It will be appreciated that the graphical layout is a final version of the graphical representation that has the plurality of objects placed in the graphical layout. For example, the graphical layout is the graphical representation of a base camp for a gaming application.

Throughout the present disclosure, the term “input graphical layout” refers to a basic version of the graphical representation that needs to be modified accordingly for the plurality of objects to be placed therein and subsequently, form the graphical layout. Optionally, the input graphical layout is received from a user via a user input. Alternatively, the input graphical layout is received from a data repository having a plurality of different input graphical layouts stored therein. Throughout the present disclosure, the term “plurality of cells” refers to constituent elements that form the input graphical layout. Notably, each cell from amongst the plurality of cells comprises one or more pixels. Optionally, each cell from amongst the plurality of cells is of a uniform size. It will be appreciated that the plurality of cells are obtained by dividing the input graphical layout into a series of rows and columns, and thus, the plurality of cells form the grid structure. Throughout the present disclosure, the term “grid structure” refers to a structural design formed by the series of rows and columns that intersect with each other to form a plurality of blocks. Notably, each cell from amongst the plurality of cells is a corresponding block in the grid structure.

Optionally, the input graphical layout is one of: an empty graphical layout devoid of objects or a partially-filled graphical layout having at least one object. In this regard, the term “empty graphical layout” refers to that version of the input graphical layout in which each cell from amongst the plurality of cells is empty, which makes the empty graphical layout devoid of the objects. Notably, the input graphical layout being the empty graphical layout devoid of the objects simplifies the placing of the plurality of objects in the input graphical layout. It will be appreciated that the term “objects” refers to a set of objects that is different from the plurality of objects. Throughout the present disclosure, the term “partially-filled graphical layout” refers to that version of the input graphical layout in which at least one object is already placed in corresponding at least one cell from amongst the plurality of cells in the input graphical layout. Notably, the term “at least one object” refers to one or more objects that are different from the plurality of the objects. It will be appreciated that the input graphical layout being the partially-filled graphical layout having the at least one object increases a number of constraints in the at least one predefined constraint as the plurality of objects cannot be placed in the corresponding at least one cell in which the at least one object is placed. A technical effect of the input graphical layout being one of: the empty graphical layout devoid of the objects or the partially-filled graphical layout having the at least one object, is that the graphical layout is effectively generated using different types of the input graphical layout.

Throughout the present disclosure, the term “plurality of objects” refers to a group of virtual objects or items that are to be placed in the input graphical layout and subsequently, form the graphical layout. It will be appreciated that the plurality of objects are to be placed in the input graphical layout by placing each object of the plurality of objects in a corresponding cell of the plurality of cells. Notably, placing each object of the plurality of objects in the corresponding cell of the plurality of cells implies visually rendering each object of the plurality of objects in the one or more pixels of the corresponding cell of the plurality of cells.

Optionally, the plurality of objects comprises objects belonging to different types, sizes, functionalities and the like. Referring to the above example, the plurality of objects are troops of different types and functionalities, where the graphical layout is to be generated for the gaming application.

Throughout the present disclosure, the term “placement probability score” refers to a set of individual probability values that indicate a probability of placing each object of the plurality of objects in the each cell of the plurality of cells at the first point in time. Notably, a cumulative value of the placement probability score is equal to one. Throughout the present disclosure, the term “first point in time” refers to an initial instance of time at which none of the plurality of objects is placed in the input graphical layout. Optionally, the first point in time is same as a point in time at which the input graphical layout is received. Notably, the placement probability score enables to determine what is the probability of placing any object from amongst the plurality of objects in any cell from amongst the plurality of cells at the first point in time.

Throughout the present disclosure, the term “given object” refers to a particular object from amongst the plurality of objects at a given point in time. Notably, placing the given object into the graphical layout implies visually rendering the given object in the graphical layout. Throughout the present disclosure, the term “predefined placement schedule” refers to a pre-planned schedule or order according to which the plurality of objects are to be placed into the input graphical layout. Herein, any object having a first priority in the predefined placement schedule is to be placed into the input graphical layout before remaining objects from amongst the plurality of objects, and vice versa. Notably, selecting the given object for the placement, based on the predefined placement schedule implies that the particular object having the first priority in the predefined placement schedule is selected as the given object to be placed into the input graphical layout before the remaining objects from amongst the plurality of objects.

Optionally, the predefined placement schedule is defined based on at least one of: an object-type, an object-size, and a structuring-plan. In this regard, the term “object-type” refers to a type or category of each object of the plurality of objects. It will be appreciated that the object-type is based on the computing application for which the graphical layout is to be generated. The object-type of each object of the plurality of objects is based on a corresponding functionality of each object of the plurality of objects in the computing application. Notably, the predefined placement schedule being defined based on the object-type implies that the priority of any object in the predefined placement schedule depends on the object-type of that object. Referring to the above example, a first object from amongst the plurality of objects having the object-type “defensive troop” is given a higher priority in the predefined placement schedule, in comparison to a second object from amongst the plurality of objects having the object-type “offensive troop” that is given a lower priority in the predefined placement schedule. Throughout the present disclosure, the term “object-size” refers to a size or dimensions of each object of the plurality of objects. For example, the object-size may be micro, small, large, and the like. Notably, the predefined placement schedule being defined based on the object-size implies that the priority of any object in the predefined placement schedule depends on the object-size of that object. Referring to the above example, a first object from amongst the plurality of objects having the object-size “small” is given the higher priority in the predefined placement schedule, in comparison to a second object from amongst the plurality of objects having the object-size “large” that is given the lower priority in the predefined placement schedule. Throughout the present disclosure, the term “structuring plan” refers to a plan that defines what type of objects are suitable to be placed in which parts of the input graphical layout. A technical effect is that the predefined placement schedule is defined after taking into consideration, all possible factors that may impact how the plurality of objects are to be placed into the input graphical layout.

Optionally, the objects belonging to similar and dis-similar object-types and object-sizes are selected based on the structuring-plan for generation of the graphical layout. In this regard, the objects belonging to the similar object-types and object-sizes implies that two or more objects of the plurality of the objects have a same object-type and the object-type. Similarly, the objects belonging to the dis-similar object-types and object-sizes implies that two or more objects of the plurality of the objects have a different object-type and the object-type. A technical effect is that the predefined placement schedule is effectively selects objects based on the structure plan.

Throughout the present disclosure, the term “predefined constraint” refers to certain limitations or conditions based on which the given object cannot be placed on a certain cell of the plurality of cells in the input graphical layout. It will be appreciated that the “at least one predefined constraint” refers to “single predefined constraint” in some implementations, and “a plurality of predefined constraints” in other implementations. Notably, the at least one predefined constraint is based on at least one of: design limitations of the input graphical layout, design limitations of the graphical layout, the functionalities of the computing application for which the graphical layout is to be generated, object-type of the given object, object-size of the given object, and the like. For example, the at least one constraint may be that if the object-type of the given object is “defensive troop”, then the given troop cannot be placed in any cell belonging to boundary region of the input graphical layout. It will be appreciated that the at least one predefined constraint varies for each different given object from amongst the plurality of objects. Notably, the at least one predefined constraint is violated when the given object is place in the certain cell where the given object cannot be placed. Throughout the present disclosure, the term “constrained cell” refers to the certain cell from amongst the plurality of cells in which placing the given object violates the at least one predefined constraint. It will be appreciated that the “one or more constrained cells” refers to “single constrained cell” in some implementations, and “a plurality of constrained cells” in other implementations. Notably, identifying the one or more constrained cells from amongst the plurality of cells implies determining the one or more certain cells from amongst the plurality of cells where the given object cannot be placed.

Optionally, the at least one predefined constraint that identifies the one or more constrained cells, is when a cell from amongst the plurality of cells is pre-occupied with an object or unsuitable to be placed with the given object based on the object-type, the object-size or the structuring-plan. In this regard, the cell from amongst the plurality of cells being pre-occupied with the given object implies that the cell is not empty for the given object to be placed therein. Subsequently, the cell from amongst the plurality of cells is identified to be part of the one or more constrained cells, as the at least one constraint gets violated by placing the given object therein. Notably, the cell from amongst the plurality of cells being unsuitable to be placed with the given object implies that the given object does not match a criteria required for any object to be placed in the cell.

In other words, the object-type, the object-size, or the structural plan associated with the given object is not compatible with requirements of the cell. A technical effect is that the at least one predefined constraint comprises all possible scenarios that creates the constraint for the given object to be placed on any cell of the plurality of cells.

Notably, the given object cannot be placed on the one or more constrained cells, and thus, the probability of placing the given object in the one or more constrained cells requires to be set to zero. Subsequently, the placement probability score is adjusted by setting the individual values of the probability of placing the given object in the one or more constrained cells to zero, in the placement probability score. It will be appreciated that adjusting the placement probability score, for the one or more constrained cells, to be zero ensures that the possibility of placing the given object in the one or more constrained cells is completely ruled out.

Throughout the present disclosure, the term “constraint-free cells” refers to specific cells from amongst the plurality of cells in which placing the given object does not violate the at least one predefined constraint. Notably, adjusting the placement probability score, for the one or more constrained cells, to be zero, increases the probability of placing the given object in each cell of the constraint-free cells in the second point in time.

Subsequently, the placement probability score for each cell of the constraint-free cells is adjusted in the second point in time due to the adjustment in the placement probability score, for the one or more constrained cells. Throughout the present disclosure, the term “second point in time” refers to a consecutively following instance of time to the first point in time. Optionally, the second point in time is after one of: microseconds, milliseconds, seconds, and the like after the first point in time. Notably, the placement probability score for each cell of the constraint-free cells being adjusted based on the placement probability score for each cell of the constraint-free cells, and the adjusted placement probability score for the one or more constrained cells implies that existing values of the probability of placing the given object in the constraint-free cells is taken into account for determining how much modification needs to be performed in the placement probability score for each cell of the constraint-free cells.

Throughout the present disclosure, the term “highest adjusted placement probability score” refers to a value of probability of placing the given object in the constraint-free cell from amongst the constraint-free cells at the second point in time being highest in comparison to the values of the probabilities of placing the given object in remaining constraint-free cells from amongst the constraint-free cells at the second point in time.

Notably, the constraint-free cell amongst the constraint-free cells, having the highest adjusted placement probability score is selected in which the given object is placed, as the probability of the placing the given object in the constraint-free cell from amongst the constraint-free cells at the second point in time is the highest. Subsequently, the given object is placed in the input graphical layout in the constraint-free cell having the highest adjusted placement probability score at the second point in time.

Optionally, the constraint-free cell having the highest adjusted placement probability score is determined by normalizing the placement probability score of the constraint-free cells. In this regard, normalizing the placement probability score of the constraint-free cells refers to adjusting the placement probability score of the constraint-free cells in a way such that the cumulative sum of all probability values in the adjusted placement probability score of the constraint-free cells equals to one. Subsequently, the constrain-free cell having the highest adjusted placement probability score is determined from the normalized placement probability score. A technical effect is that the constraint-free cell having the highest adjusted placement probability score is effectively and accurately determined.

Optionally, the method further comprising adjusting the placement probability score, for each cell of constraint-free cells with respect to a subsequent object to the given object at a third point in time, and wherein the subsequent object is placed in a constraint-free cell having a highest adjusted placement probability score with respect to the subsequent object at the third point in time. In this regard, the term “subsequent object” refers to that object from amongst the plurality of objects that has a second highest priority in the predefined placement schedule after the given object to be placed in the input graphical layout. Notably, the constraint-free cells with respect to the subsequent object to the given object refers to those cells from amongst the plurality cells in which the subsequent object can be placed without violating the at least one predefined constraint at the third point in time after the given object has been placed into the input graphical layout. Throughout the present disclosure, the term “third point in time” refers to a consecutively following instance of time to the second point in time. Optionally, a time difference between the first point in time and second point in time is equal as that of between the second point in time and the third point in time. It will appreciated that the placement probability score, for each cell of the constraint-free cells with respect to the subsequent object at the third point in time enables to determine probability values of placing the subsequent object in each cell of the constraint-free cells with respect to the subsequent object at the third point in time. Subsequently, placing the subsequent object in the constraint-free cell having the highest adjusted placement probability score with respect to the subsequent object at the third point in time implies that the subsequent object is placed in the constraint-free cell for which the probability value of placing the subsequent object therein at the third point in time is highest in comparison to the probability values of placing the subsequent object in remaining constraint-free cells from amongst the constraint-free cells with respect to the subsequent object at the third point in time. A technical effect is that the subsequent object is effectively and accurately placed in the input graphical layout in the constraint-free cell having the highest adjusted placement probability score with respect to the subsequent object at the third point in time.

Optionally, adjusting the placement probability score for each cell of the constraint-free cells with respect to the subsequent object is further based on adjusted placement probability score for the one or more constrained cells with respect to the given object at the third point time. In this regard, after the given object is placed in the input graphical layout, the constrained one or more cells changes and subsequently, the placement probability score for the one or more constrained cells with respect to the given object is adjusted at the third point time, to take into account the change in the one or more constrained cells after the given object is placed in the input graphical layout. A technical effect is that the placement probability score for each cell of the constraint-free cells with respect to the subsequent object is adjusted with improved accuracy by taking into account the adjusted placement probability score for the one or more constrained cells with respect to the given object at the third point time.

Optionally, determining and adjusting the placement probability scores for each cell of the plurality of cells with respect to the given and subsequent objects of the plurality of objects at the first, second and third points in time are performed using an Artificial intelligence model. In this regard, the term “Artificial intelligence model” refers to a computing model that automates a process of determining and adjusting the placement probability scores by implementing machine learning algorithms. A technical effect is that the placement probability scores are accurately determined and adjusted at a faster rate.

Optionally, the Artificial intelligence model is a neural network model based on an encoder decoder Vision Transformer model operable based on a discrete diffusion process for determining and adjusting the placement probability scores. In this regard, the term “neural network model” refers to a computing model that replicates a functioning of a human brain, which is able to learn patterns, make predictions, and perform tasks based on learning from training data. Throughout the present disclosure, the term “discrete diffusion process” refers to a stochastic process that spreads the determining and adjusting of the probability placement scores across various discrete points in time. A technical effect is that an accuracy of determining and adjusting the placement probability scores can be evaluated at each discrete point in time.

The present disclosure also relates to the system as described above. Various embodiments and variants disclosed above, with respect to the aforementioned method, apply mutatis mutandis to the system.

Throughout the present disclosure, the term “processor” refers to a computational element that is operable to execute instructions of the system for generating the graphical layout. Examples of the processor include, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit.

Furthermore, the processor may refer to one or more individual servers, processing devices and various elements associated with a processing device that may be shared by other processing devices. Additionally, one or more individual servers, processing devices and elements are arranged in various architectures for responding to and processing the instructions that execute the instructions of the system for generating the graphical layout.

Optionally, the processor is further configured to adjust the placement probability score, for each cell of constraint-free cells with respect to a subsequent object to the given object at a third point in time, and wherein the subsequent object is placed in a constraint-free cell having a highest adjusted placement probability score with respect to the subsequent object at the third point in time.

Optionally, adjusting the placement probability score for each cell of the constraint-free cells with respect to the subsequent object is further based on adjusted placement probability score for the one or more constrained cells with respect to the given object at the third point time.

Optionally, the predefined placement schedule is defined based on at least one of: an object-type, an object-size, and a structuring-plan.

Optionally, the at least one predefined constraint that identifies the one or more constrained cells, is when a cell from amongst the plurality of cells is pre-occupied with an object or unsuitable to be placed with the given object based on the object-type, the object-size or the structuring-plan.

Present disclosure has been found, surprisingly, to provide feasible graphical layouts, significant more efficient way, in comparison to, for example to brute force methods in which all combinations are tested. Furthermore, the present disclosure efficiency is superior when number of objects is increased. In brute force methods complexity increases geometrically, in present method in linear or close to linear manner. As discussed, the graphical layouts can be used for various planning, computer programs and a like. In one embodiment graphical layouts are used to autogenerate levels for a game. In other embodiment the graphical layouts could be used to organize icons on computer screen. Further the layouts can be used to automatically organize also real-world objects and control storage systems automatization.

### DETAILED DESCRIPTION OF THE DRAWINGS

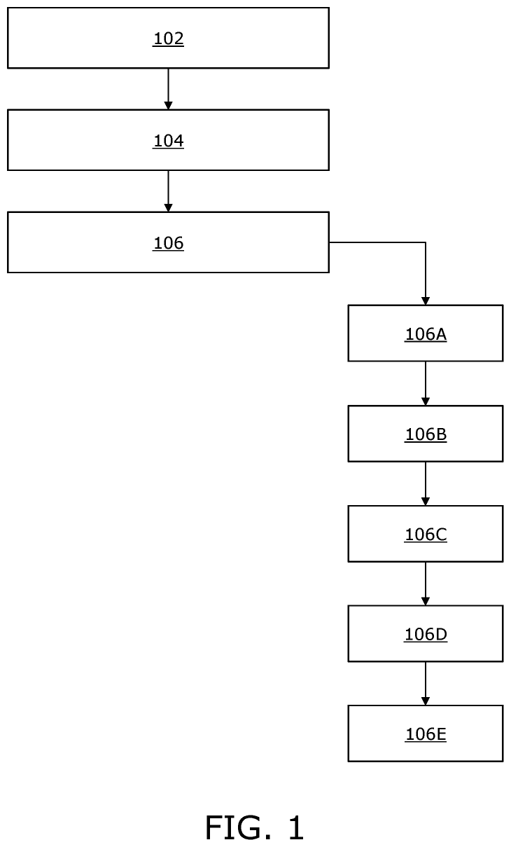

Referring to FIG. 1, illustrated is a flowchart depicting steps of a method for generating a graphical layout, in accordance with an embodiment of the present disclosure. At step 102, an input graphical layout having a plurality of cells forming a grid structure, is received, the plurality of cells are configured to be placed with a plurality of objects to form the graphical layout. At step 104, a placement probability score for each cell of the plurality of cells with respect to each object of the plurality of objects at a first point in time, is determined. At step 106, each object of the plurality of objects is placed into the input graphical layout for forming the graphical layout, wherein for placing a given object into the input graphical layout; at step 106A, the given object is selected for placement, based on a predefined placement schedule; at step 106B, one or more constrained cells (C2) from amongst the plurality of cells are identified, where at least one predefined constraint is violated if the given object is placed thereon; at step 106C, the placement probability score, for the one or more constrained cells, is adjusted to be zero; and at step 106D, the placement probability score, for each cell of constraint-free cells from amongst the plurality of cells with respect to the given object at a second point in time, is adjusted based on the placement probability score for each cell of the constraint-free cells, and the adjusted placement probability score for the one or more constrained cells; wherein at step 106E, the given object is placed in a constraint-free cell having a highest adjusted placement probability score amongst the constraint-free cells with respect to the given object at the second point in time.

The aforementioned steps are only illustrative and other alternatives can also be provided where one or more steps are added, one or more steps are removed, or one or more steps are provided in a different sequence without departing from the scope of the claims herein.

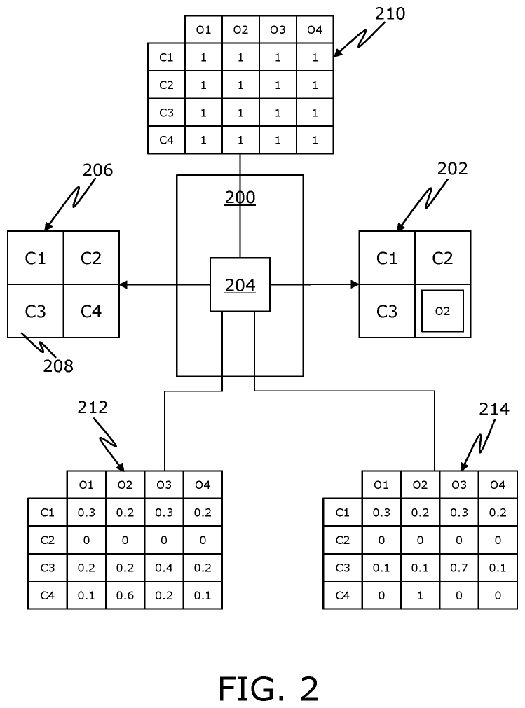

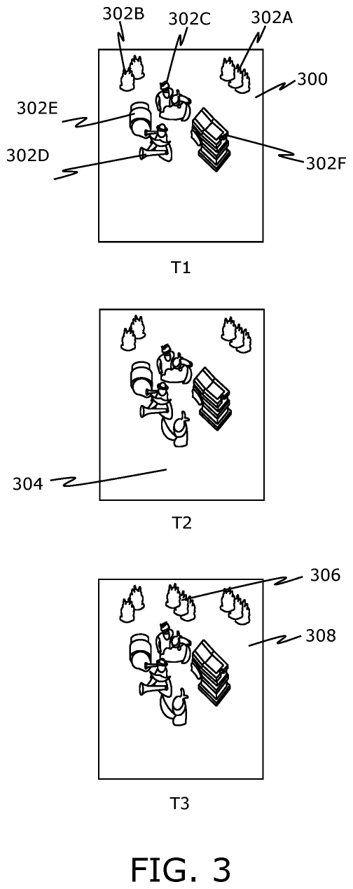

Referring to FIG. 2, illustrated is a schematic illustration of a system 200 for generating a graphical layout 202, in accordance with an embodiment of the present disclosure. The system 200 comprises a processor 204 configured to receive an input graphical layout 206 having a plurality of cells C1-4 forming a grid structure 208, the plurality of cells C1-4 are configured to be placed with a plurality of objects O1-4 to form the graphical layout 202. Moreover, the processor 204 is configured to determine a placement probability score 210 for each cell of the plurality of cells C1-4 with respect to each object of the plurality of objects O1-4 at a first point time. Furthermore, the processor 204 is configured to place each object of the plurality of objects O1-4 into the input graphical layout 206 for forming the graphical layout 202, wherein placing a given object O2 into the input graphical layout 206 comprises selecting the given object O2 for placement, based on a predefined placement schedule; identifying one or more constrained cells (depicted as cell C2) from amongst the plurality of cells C1-4 where at least one predefined constraint is violated if the given object O2 is placed thereon; adjusting the placement probability score 212 for the one or more constrained cells C2, to be zero; adjusting the placement probability score 214, for each cell of constraint-free cells C1, C3, and C4 from amongst the plurality of cells C1-4 with respect to the given object O2 at a second point in time, based on the placement probability score 214 for each cell of the constraint-free cells C1, C3, and C4, and the adjusted placement probability score 212 for the one or more constrained cells C2, wherein the given object O2 is placed in a constraint-free cell C4 having a highest adjusted placement probability score amongst the constraint-free cells C1, C3, and C4 with respect to the given object O2 at the second point in time. Optionally, the processor 204 is further configured to adjust the placement probability score 214, for each cell of constraint-free cells C1 and C3 with respect to a subsequent object O3 to the given object O2 at a third point in time, and wherein the subsequent object O3 is placed in a constraint-free cell C3 having a highest adjusted placement probability score with respect to the subsequent object O3 at the third point in time. Referring to FIG. 3, illustrated is a schematic illustration of an input graphical layout 300 at different points in time, in accordance with an embodiment of the present disclosure. As shown, at a first point in time T1, the input graphical layout 300 is a partially-filled graphical layout having at least one object (depicted as a first object 302A, a second object 302B, a third object 302C, a fourth object 302D, a fifth object 302E, and a sixth object 302F). At a second point in time T2, a given object 304 is placed in the input graphical layout 300. At a third point in time T3, a subsequent object 306 to the given object 304 is placed in the input graphical layout 300 for forming a graphical layout 308. In one example graphical layout of FIG. 3 is a layout of a game user interface. Objects are objects (such as buildings) of the game and the layout generator is used to find a layout which is feasible and does not violate placement rules. Technical effect of generating layout in this way is that a layout can be generated faster than for example trying out all permutations.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for generating a graphical layout, the method comprising:
receiving an input graphical layout having a plurality of cells (C1-4) forming a grid structure, the plurality of cells are configured to be placed with a plurality of objects (O1-4) to form the graphical layout;
determining a placement probability score for each cell of the plurality of cells with respect to each object of the plurality of objects at a first point in time (T1);
placing each object of the plurality of objects into the input graphical layout for forming the graphical layout, wherein placing a given object (O2, 304) into the input graphical layout comprises:
selecting the given object for placement, based on a predefined placement schedule;
identifying one or more constrained cells (C2) from amongst the plurality of cells where at least one predefined constraint is violated if the given object is placed thereon;
adjusting the placement probability score, for the one or more constrained cells, to be zero;
adjusting the placement probability score, for each cell of constraint-free cells (C1, C3, C4) from amongst the plurality of cells with respect to the given object at a second point in time (T2), based on
the placement probability score for each cell of the constraint-free cells, and
the adjusted placement probability score for the one or more constrained cells,
wherein the given object is placed in a constraint-free cell (C4) having a highest adjusted placement probability score amongst the constraint-free cells with respect to the given object at the second point in time.

2. The method according to claim 1, further comprising adjusting the placement probability score (214), for each cell of constraint-free cells (C1, C3) with respect to a subsequent object (O3, 306) to the given object (O2, 304) at a third point in time (T3), and wherein the subsequent object is placed in a constraint-free cell (C3) having a highest adjusted placement probability score with respect to the subsequent object at the third point in time.

3. The method according to claim 2, wherein adjusting the placement probability score for each cell of the constraint-free cells (C1, C3) with respect to the subsequent object (O3, 306) is further based on adjusted placement probability score for the one or more constrained cells (C2, C4) with respect to the given object (O2, 304) at the third point time (T3).

4. The method according to claim 3, wherein determining and adjusting the placement probability scores for each cell of the plurality of cells (C1-4) with respect to the given and subsequent objects (O2, O3) of the plurality of objects (O1-4) at the first, second and third points in time (T1-3) are performed using an Artificial intelligence model.

5. The method according to claim 4, wherein the Artificial intelligence model is a neural network model based on an encoder decoder Vision Transformer model operable based on a discrete diffusion process for determining and adjusting the placement probability scores.

6. The method according to claim 1, wherein the input graphical layout is one of: an empty graphical layout devoid of objects or a partially-filled graphical layout having at least one object.

7. The method according to claim 1, wherein the predefined placement schedule is defined based on at least one of: an object-type, an object-size, and a structuring-plan.

8. The method according to claim 7, wherein objects belonging to similar and dis-similar object-types and object-sizes are selected based on the structuring-plan for generation of the graphical layout.

9. The method according to claim 7, wherein the at least one predefined constraint that identifies the one or more constrained cells (C1, C3, C4), is when a cell from amongst the plurality of cells (C1-4) is pre-occupied with an object or unsuitable to be placed with the given object (O2, 304) based on the object-type, the object-size or the structuring-plan.

10. The method according to claim 1, wherein the constraint-free cell having the highest adjusted placement probability score is determined by normalizing the placement probability score of the constraint-free cells.

11. A system for generating a graphical layout, the system comprising a processor configured to:
receive an input graphical layout having a plurality of cells (C1-4) forming a grid structure, the plurality of cells are configured to be placed with a plurality of objects (O1-4) to form the graphical layout;
determine a placement probability score for each cell of the plurality of cells with respect to each object of the plurality of objects at a first point in time (T1);
place each object of the plurality of objects into the input graphical layout for forming the graphical layout, wherein placing a given object (O2, 304) into the input graphical layout comprises:
selecting the given object for placement, based on a predefined placement schedule;
identifying one or more constrained cells (C2) from amongst the plurality of cells where at least one predefined constraint is violated if the given object is placed thereon;
adjusting the placement probability score, for the one or more constrained cells, to be zero;
adjusting the placement probability score, for each cell of constraint-free cells (C1, C3, C4) from amongst the plurality of cells with respect to the given object at a second point in time (T2), based on
the placement probability score for each cell of the constraint-free cells, and
the adjusted placement probability score for the one or more constrained cells,
wherein the given object is placed in a constraint-free cell (C4) having a highest adjusted placement probability score amongst the constraint-free cells with respect to the given object at the second point in time.

12. The system according to claim 11, wherein the processor is further configured to adjust the placement probability score, for each cell of constraint-free cells (C1, C3) with respect to a subsequent object (O3, 306) to the given object (O2, 304) at a third point in time (T3), and wherein the subsequent object is placed in a constraint-free cell (C3) having a highest adjusted placement probability score with respect to the subsequent object at the third point in time.

13. The system according to claim 12, wherein adjusting the placement probability score (214) for each cell of the constraint-free cells (C1, C3) with respect to the subsequent object (O3) is further based on adjusted placement probability score for the one or more constrained cells (C4) with respect to the given object (O2, 304) at the third point time (T3).

14. The system (200) according to claim 11, wherein the predefined placement schedule is defined based on at least one of: an object-type, an object-size, and a structuring-plan.

15. The system according to claim 14, wherein the at least one predefined constraint that identifies the one or more constrained cells (C1, C3, C4), is when a cell from amongst the plurality of cells (C1-4) is pre-occupied with an object or unsuitable to be placed with the given object (O2, 304) based on the object-type. the object-size or the structuring-plan.
